(19) United States
(12) Patent Application Publication
(10) Pub. No.: US 2012/0212586 A1
(43) Pub. Date: Aug. 23, 2012

(54) DEVICE AND METHOD FOR CONVERGENCE OF STEREOSCOPIC DIGITAL IMAGING

(75) Inventors: Zhen Li, Shenzhen (CN); Denghai Xia, Shenzhen (CN); Wei Li, Shenzhen (CN)

(73) Assignee: INLIFE-HANDNET CO., LTD., Shenzhen, Guangdong (CN)

(21) Appl. No.: 13/498,265

(22) PCT Filed: Jan. 7, 2010
(86) PCT No.: PCT/CN2010/070056

§ 371 Date: May 4, 2012

(30) Foreign Application Priority Data
Sep. 27, 2009 (CN) 200910190752.8

(51) Int. Cl. H04N 13/02

(52) U.S. Cl. 348/47; 348/E13.074

(57) ABSTRACT

A stereoscopic digital imaging convergence device includes an image receiving module (100) for receiving a left image and a right image, an image selecting module (200) for selecting a left sub-image from the left image and a right sub-image from the right image, a display screen (300) for displaying the left sub-image and the right sub-image, a manual adjusting module (400) for receiving an adjusting command made by users after observing the image displayed on the display screen, an image adjusting module (500) for correspondingly adjusting the position of the left sub-image and the right sub-image selected by the image selecting module according to the adjusting command. Meanwhile, a convergence method of stereoscopic digital imaging is disclosed.

### FIELD OF THE INVENTION

The present invention relates to a technical field of stereoscopic digital imaging, more specifically, to a device and method for convergence of stereoscopic digital imaging.

### BACKGROUND OF THE UTILITY MODEL

With the development of 3D stereoscopic technology, 3D digital products have entered common consumers' life gradually. In addition to its application in the field of display product, 3D technology is also employed for digital camera. As a result, people come to know 3D stereoscopic digital imaging equipment, e.g. stereoscopic digital camera that can take more real images. The principle for forming stereoscopic images of the stereoscopic digital camera is as follows: two imaging sensors are utilized to simulate human eyes to view objects. In detail, two lens groups and imaging sensors are utilized to obtain visual error of bionic eyes and gradation for objects far and near, wherein such two lens groups and imaging sensors are spaced apart to a certain extent, and their optical axes are in parallel with each other.

However, when the stereoscopic digital camera is used for taking a picture or photographing, two lenses and sensors are in operation at the same time to capture images respectively. Due to the differences between such lenses and sensors themselves, the error during installation, or the differences between the parallax errors for different human eyes, there are many problems for two groups of image data output by the two lenses and sensors, which include that in the two groups of image data, the focal point does not converge and positions have deviated. In such instance, the stereoscopic image displayed on the stereoscopic digital imaging equipment (e.g., stereoscopic digital camera) will deviate and the focal point will not converge, thus influencing the stereoscopic imaging effect.

### SUMMARY OF THE INVENTION

The objective of the present invention is to provide a device and method for convergence of stereoscopic digital imaging, aiming at the drawbacks that the focal point does not converge and the positions deviate for bilateral images collected by the stereoscopic digital imaging equipment in the prior art.

In order to achieve the above-mentioned object, the following technical solution is employed in the present invention: a device and method for convergence of stereoscopic digital imaging are provided. Firstly, a left sub-image and a right sub-image that are displayed on a display screen are selected from a left image and a right image by an image selecting module respectively. Then an adjusting command made by users after observing the images displayed on the display screen is received by a manual adjusting module. After that, the positions of the left sub-image and the right sub-image selected by the image selecting module are adjusted by an image adjusting module according to the adjusting command. Finally, the positions of the left sub-image and the right sub-image after adjustment are displayed.

According to an aspect, a device for convergence of stereoscopic digital imaging is provided, which is arranged in a stereoscopic digital imaging device. The stereoscopic digital imaging device is provided with a left image collecting module for taking a left image imitating the left eye and a right image collecting module for taking a right image imitating the right eye. The device for convergence of stereoscopic digital imaging comprises:

an image receiving module, which is connected with the left image collecting module and the right image collecting module respectively and used for receiving the left image imitating the left eye and the right image imitating the right eye, wherein both the left image and the right image are in a size with M rows and N columns; the M and N are both positive integers;

an image selecting module, which is used for selecting a left sub-image and a right sub-image from the left image and the right image respectively; wherein both the left sub-image and the right sub-image are in a size with L rows and S columns and further displayed on a display screen; the L and S are both positive integers, while the L is smaller than the M and the S is smaller than the N;

the display screen, which is used for displaying the left sub-image and the right sub-image;

a manual adjusting module, which is used for receiving an adjusting command made by users after observing the image displayed on the display screen;

an image adjusting module, which is used for correspondingly adjusting the positions of the left sub-image and the right sub-image selected by the image selecting module according to the adjusting command.

In the device for convergence of stereoscopic digital imaging, the manual adjusting module is used for receiving an adjusting command for adjusting in the horizontal direction and/or an adjusting command for adjusting in the vertical direction made by users.

In the device for convergence of stereoscopic digital imaging, the image adjusting module is used for correspondingly adjusting the positions of the selected left sub-image and the selected right sub-image in the horizontal direction and/or in the vertical direction according to the adjusting command for adjusting in the horizontal direction and/or the adjusting command for adjusting in the vertical direction.

In the device for convergence of stereoscopic digital imaging, the image selecting module is used for selecting the left sub-image and the right sub-image by selecting a starting coordinate for the left sub-image on the left image and a starting coordinate for the right sub-image on the right image.

In the device for convergence of stereoscopic digital imaging, the image adjusting module is used for adjusting the starting coordinate for the left sub-image and the starting coordinate for the right sub-image according to the adjusting command so as to adjust the positions of the selected left sub-image and the selected right sub-image.

According to another aspect, a method for convergence of stereoscopic digital imaging is provided, comprising the following steps:

S1: receiving a left image imitating the left eye and a right image imitating the right eye, wherein both the left image and the right image are in a size with M rows and N columns; the M and N are both positive integers;

S2: selecting a left sub-image from the left image, selecting a right sub-image from the right image, and displaying the left sub-image and the right sub-image on a display screen; wherein both the left sub-image and the right sub-image are in a size with L rows and S columns; the L and S are both positive integers, while the L is smaller than the M and the S is smaller than the N;

S3: receiving an adjusting command made by users after observing the images displayed on the display screen;

S4: correspondingly adjusting the positions of the selected left sub-image and the selected right sub-image according to the adjusting command, and then displaying the re-selected left sub-image and the re-selected right sub-image on the display screen.

In the method for convergence of stereoscopic digital imaging, the step S3 includes: receiving the adjusting command for adjusting in the horizontal direction and/or the adjusting command for adjusting in the vertical direction made by users.

In the method for convergence of stereoscopic digital imaging, the step S4 includes: adjusting the positions of the selected left sub-image and the selected right sub-image in the horizontal direction and/or in the vertical direction according to the adjusting command for adjusting in the horizontal direction and/or the adjusting command for adjusting in the vertical direction.

In the method for convergence of stereoscopic digital imaging, the step S2 includes: selecting the left sub-image and the right sub-image by selecting a starting coordinate for the left sub-image on the left image and a starting coordinate for the right sub-image on the right image,

In the method for convergence of stereoscopic digital imaging, the step S4 includes: adjusting the starting coordinate for the left sub-image and the starting coordinate for the right sub-image according to the adjusting command so as to adjust the positions of the selected left sub-image and the selected right sub-image.

When implementing the present invention, the following advantageous effect can be achieved: in the present invention, the focal points in two groups of images output by the two lenses and sensors are converged effectively. In the present invention, the following problems are solved effectively: for the two groups of image data output by the two lenses and sensors, the positions deviate and the focal point does not converge due to the differences between such lenses and sensors themselves, the error during installation, or the differences between the parallax errors for different human eyes. Therefore, the stereoscopic display effect of the stereoscopic digital imaging equipment (such as the stereoscopic digital camera) is further guaranteed.

### BRIEF DESCRIPTION OF THE DRAWINGS

The present invention will be described in detail with reference to the accompanying drawings and embodiments in the following. In the figures:

FIG. 1 is a structure diagram for an embodiment of the device for convergence of stereoscopic digital imaging in the present invention;

FIG. 2 is a flowchart for an embodiment of the method for convergence of stereoscopic digital imaging in the present invention;

FIG. 3 is schematic diagram for selecting a left sub-image in the method for convergence of stereoscopic digital imaging in the present invention;

FIG. 4 is schematic diagram for selecting a right sub-image in the method for convergence of stereoscopic digital imaging in the present invention.

### DETAILED DESCRIPTION OF THE PREFERRED EMBODIMENT

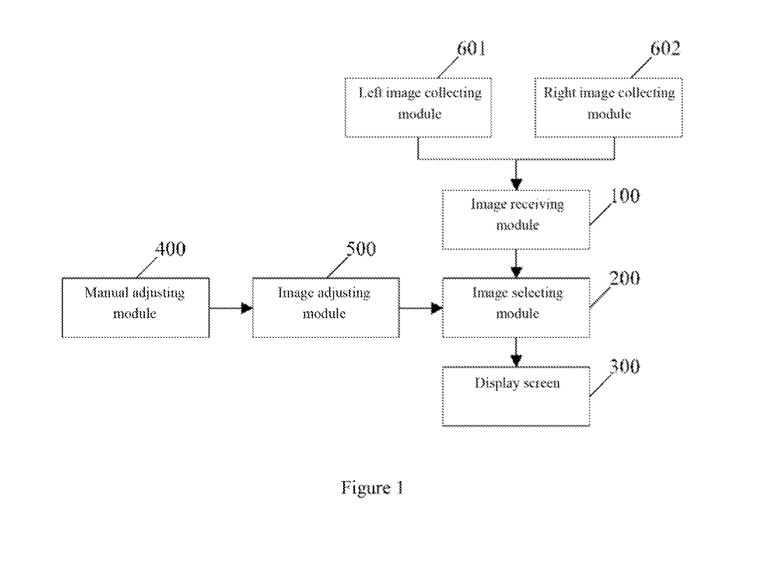

Referring to FIG. 1, it is a structure diagram of the device for convergence of stereoscopic digital imaging provided in an embodiment of the present invention. Such device comprises an image receiving module 100, an image selecting module 200, a display screen 300, a manual adjusting module 400 and an image adjusting module 500. The device for convergence of stereoscopic digital imaging is arranged in a stereoscopic digital imaging device. The stereoscopic digital imaging device is provided with a left image collecting module 601 for taking a left image imitating the left eye and a right image collecting module 602 for taking a right image imitating the right eye. In common sense, the left image collecting module corresponds to a left lens and a left image sensor, and the right image collecting module corresponds to a right lens and a right image sensor.

The image receiving module 100 is connected with the left image collecting module 601 and the right image collecting module 602 respectively It is used for receiving the left image imitating the left eye and the right image imitating the right eye. Wherein both the left image and the right image are in a size with rows and N columns, and the M and N are both positive integers.

The image selecting module 200 is connected with the image receiving module 100. It is used for selecting a left sub-image and a right sub-image from the left image and the right image respectively. Wherein both the left sub-image and the right sub-image are in a size with L rows and S columns and further displayed on a display screen 300. The and S are both positive integers, and the value of L is smaller than that of M and the value of S is smaller than that of N. Further, the image selecting module 200 is used for selecting the left sub-image and the right sub-image by selecting a starting coordinate for the left sub-image on the left image and a starting coordinate for the right sub-image on the right image.

The display screen 300 is connected with the image selecting module 200. It is is used for displaying the left sub-image and the right sub-image.

The manual adjusting module 400 is used for receiving an adjusting command made by users after observing the image displayed on the display screen 300. The manual adjusting module 400 can receive the adjusting command for adjusting in the horizontal direction and/or the adjusting command for adjusting in the vertical direction which is made by users.

The image adjusting module 500 is connected with the manual adjusting module 400. It is used for correspondingly adjusting the positions of the left sub-image and the right sub-image selected by the image selecting module 200 according to the adjusting command. The image adjusting module 500 can adjust the positions of the selected left sub-image and the selected right sub-image in the horizontal direction and/or in the vertical direction according to the above adjusting command for adjusting in the horizontal direction and/or in the vertical direction. The image adjusting module 500 can adjust the starting coordinate for the left sub-image and the starting coordinate for the right sub-image according to the adjusting command so as to adjust the positions of the selected left sub-image and the selected right sub-image.

In the present invention, a method for convergence of stereoscopic digital imaging is also provided, comprising the following steps:

in step S1, a left image imitating the left eye and, a right image imitating the right eye are received; wherein both the left image and the right image are in a size with M rows and N columns, and the M and the N are both positive integers;

in step S2, a left sub-image and a right sub-image are selected from the left image and the right image respectively; the left sub-image and the right sub-image are then displayed on a display screen; wherein both the left sub-image and the right sub-image are in a size with L rows and S columns; the L and S are both positive integers while the L is smaller than the M and the S is smaller than the N;

in step S3, an adjusting command made by users after observing the images displayed on the display screen is received; the adjusting command comprises the an adjusting command for adjusting in the horizontal direction and/or an adjusting command for adjusting in the vertical direction;

in step S4, the positions of the selected left sub-image and the selected right sub-image are correspondingly adjusted according to the adjusting command, and then the re-selected left sub-image and the re-selected right sub-image are displayed on the display screen. Herein, the positions of the selected left sub-image and the selected right sub-image can be adjusted in the horizontal direction and/or in the vertical direction according to the adjusting command for adjusting in the horizontal direction and/or in the vertical direction. The positions of the selected left sub-image and the selected right sub-image can be adjusted by adjusting the starting coordinate for the left sub-image and the starting coordinate for the right sub-image according to the adjusting command.

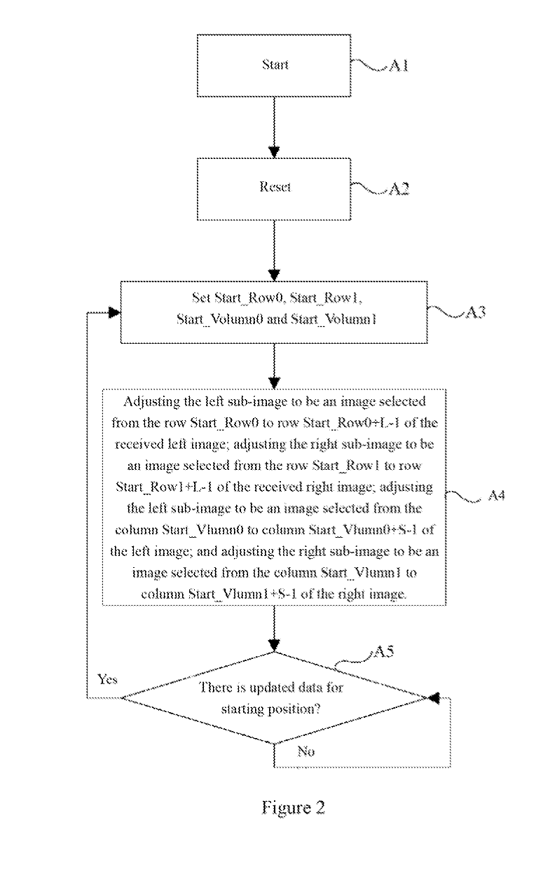

Referring to FIG. 2, it is a flowchart of the method for convergence of stereoscopic digital imaging in an embodiment of the present invention. There are mainly the following steps:

A1: the procedure is started;

A2: all parameters are reset;

A3: the parameters Stare_Row0, Start_Row1, Start_Volumn0 and Start_Volumn1 are correspondingly assigned with a value according to the received adjusting command (including the adjusting command for adjusting in the horizontal direction and/or in the vertical direction);

A4: the left sub-image is adjusted to be an image selected from the row Start_Row0 to row Start_Row0+L-1 of the received left image; the right sub-image is adjusted to be an image selected from the row Start_Row1 to row Start_Row1+L-1 of the received right image; the left sub-image is adjusted to be an image selected from the column Start_Vlumn0 to column Start_Vlumn0+S-1 of the left image; and the right sub-image is adjusted to be an image selected from the column Start_Vlumn1 to column Start_Vlumn1+S-1 of the right image.

A5: it is detected whether there is updated data for the starting position. If so, turn to step A3; if not, turn to step A5 and keep waiting for updated data.

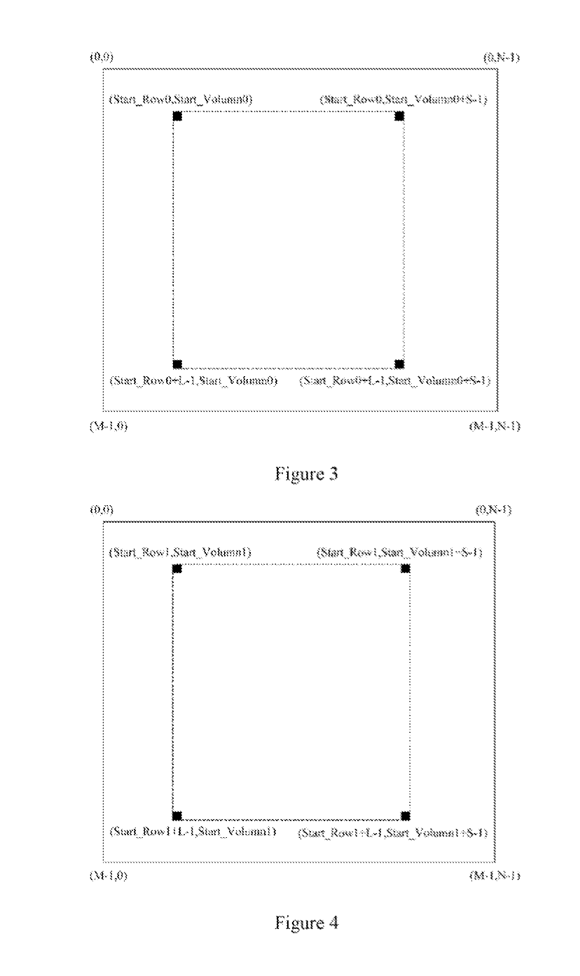

Referring to FIG. 3 and FIG. 4, they are the schematic diagrams for selecting a left sub-image and a right sub-image in the method for convergence of stereoscopic digital imaging in the present invention. The principle will be analyzed with reference to FIG. 3 and FIG. 4 in the following. As shown in FIG. 3 and FIG. 4, in the left image collected by the left image collecting module 601 and the right image collected by the right image collecting module 602, the effective pixels for every frame of video or still images is in a size with M rows and N columns, that is, the total number of the pixels is M×N. However, the positions for the collected left image and the collected right image may be deviated due to the differences between various lenses and sensors, the error during installation or the differences between parallax errors for different human eyes. For example, if the assembly position for the left lens is relatively higher, the vertical positions for the left and right images will be inconsistent. Likewise, it is also possible for the horizontal positions to be inconsistent.

By means of the above mentioned procedure, a proper left sub-image and a proper right sub-image can respectively be selected from the left image and the right image as the output in the present invention. The key point for the present invention lies in that the selected left sub-image and the selected right sub-image can be adjusted manually by the users, so as to ensure that the output left image and the output right image remain uniform both in the horizontal and vertical position. The specific way is as follows: a function key is adjusted manually at first; then the adjusting information is received by a main control; after that, starting coordinates for an output image is sent to a FPGA; finally, the starting coordinates for the output image are set to be (Start_Row0, Start_Volumn0) and (Start_Row1, Start_Volumn1) by the FPGA, wherein the adjustment in a vertical direction is achieved by the modification of Start_Row0 and Start_Row1, and the adjustment in a horizontal direction is achieved by the modification of Start_Volumn0 and Start_Volumn1. In FIG. 3 and FIG. 4, the pixels for the selected left sub-image and the selected right sub-image can be chosen based on different starting coordinates (Start_Row0, Start_Volumn0) and (Start_Row1, Start_Volumn1).

In conclusion, in the present invention, the left sub-image and the right sub-image are selected from the left image and right image by the image selecting module respectively, which are displayed on the display screen later. After that, the manual adjusting module is used for receiving the adjusting command made by users after observing the image displayed on the display screen. At last, the positions of the left sub-image and the right sub-image selected by the image selecting module according to the adjusting command are correspondingly adjusted by the image adjusting module, which are further displayed. Therefore, in the present invention, the focal points in two groups of images output by the two lenses and sensors are converged effectively. In the present invention, the following problems are solved effectively: for the two groups of image data output by the two lenses and sensors, the positions deviate and the focal point does not converge due to the differences between such lenses and sensors themselves, the error during installation, or the differences between the parallax errors for different human eyes. Therefore, the stereoscopic display effect of the stereoscopic digital imaging equipment (such as the stereoscopic digital camera) is further guaranteed.

Although the present invention is described with reference to presented implementation, it should be understood by the skills in the art that the above mentioned implementation are only intended for explaining the present invention, instead of limiting the scope of the present invention. Any modifications, equivalent replacement or improvement made in the spirit of scope of the present invention should be included in the scope of the appended claims of the present invention.

1. A device for convergence of stereoscopic digital imaging, wherein the device for convergence of stereoscopic digital imaging is arranged in a stereoscopic digital imaging device, which is provided with a left image collecting module (601) for taking a left image imitating the left eye and a right image collecting module (602) for taking a right image imitating the right eye; the device for convergence of stereoscopic digital imaging comprises:
an image receiving module (100), which is connected with the left image collecting module (601) and the right image collecting module (602) respectively and used for receiving the left image imitating the left eye and the right image imitating the right eye, wherein both the left image and the right image are in a size with M rows and N columns; M and N are both positive integers;
an image selecting module (200), which is used for selecting a left sub-image and a right sub-image from the left image and the right image respectively, wherein both the left sub-image and the right sub-image are in a size with L rows and S columns and displayed on a display screen (300); L and S are both positive integers, and the value of L is smaller than that of M and the value of S is smaller than that of N;
the display screen (300), which is used for displaying the left sub-image and the right sub-image;
a manual adjusting module (400), which is used for receiving an adjusting command made by users after observing the images displayed on the display screen (300);
an image adjusting module (500), which is used for correspondingly adjusting the positions of the left sub-image and the right sub-image selected by the image selecting module (200) according to the adjusting command.

2. The device for convergence of stereoscopic digital imaging of claim 1, wherein the manual adjusting module (400) is used for receiving an adjusting command for adjusting in the horizontal direction and/or an adjusting command for adjusting in the vertical direction made by users.

3. The device for convergence of stereoscopic digital imaging of claim 2, wherein the image adjusting module (500) is used for adjusting the positions of the selected left sub-image and the selected right sub-image in the horizontal direction and/or in the vertical direction according to the adjusting command for adjusting in the horizontal direction and/or the adjusting command for adjusting in the vertical direction.

4. The device for convergence of stereoscopic digital imaging of claim 1, wherein the image selecting module (200) is used for selecting the left sub-image and the right sub-image by selecting a starting coordinate for the left sub-image on the left image and a starting coordinate for the right sub-image on the right image.

5. The device for convergence of stereoscopic digital imaging of claim 4, wherein the image adjusting module (500) is used for adjusting the starting coordinate for the left sub-image and the starting coordinate for the right sub-image according to the adjusting command so as to adjust the positions of the selected left sub-image and the selected right sub-image.

6. A method for convergence of stereoscopic digital imaging, wherein comprising the following steps:
S1: receiving a left image imitating the left eye and a right image imitating the right eye, wherein both the left image and the right image are in a size with M rows and N columns, and M and N are both positive integers;
S2: selecting a left sub-image from the left image, selecting a right sub-image from the right image, and displaying the left sub-image and the right sub-image on a display screen; wherein both the left sub-image and the right sub-image are images in a size with L rows and S columns; L and S are both positive integers, and the value of L is smaller than that of M and the value of S is smaller than that of N;
S3: receiving an adjusting command made by users after observing the image displayed on the display screen;
S4: correspondingly adjusting the positions of the selected left sub-image and the selected right sub-image according to the adjusting command, and then displaying the re-selected left sub-image and the re-selected right sub-image on the display screen.

7. The method for convergence of stereoscopic digital imaging of claim 6, wherein the step S3 includes: receiving the adjusting command for adjusting in the horizontal direction and/or the adjusting command fix adjusting in the vertical direction made by users.

8. The method for convergence of stereoscopic digital imaging of claim 7, wherein, the step S4 includes: adjusting the positions of the selected left sub-image and the selected right sub-image in the horizontal direction and/or in the vertical direction according to the adjusting command for adjusting in the horizontal direction and/or the adjusting command for adjusting in the vertical direction.

9. The method for convergence of stereoscopic digital imaging of claim 6, wherein, the step S2 includes: selecting the left sub-image and the right sub-image by selecting a starting coordinate for the left sub-image on the left image and a starting coordinate for the right sub-image on the right image.

10. The method for convergence of stereoscopic digital imaging of claim 9, wherein, the step S4 includes: adjusting the starting coordinate for the left sub-image and the starting coordinate for the right sub-image according to the adjusting command so as to adjust the positions of the selected left sub-image and the selected right sub-image.
